(19) United States
(12) Patent Application Publication
(10) Pub. No.: US 2023/0321467 A1
(43) Pub. Date: Oct. 12, 2023

(54) SEALING FOAM RESPIRATOR, AND METHOD FOR MANUFACTURING SEALING FOAM

(71) Applicant: 3M INNOVATIVE PROPERTIES COMPANY, St. Paul, MN (US)

(72) Inventors: Zhigang Yu, Shanghai (CN); Thomas J. Xue, Woodbury, MN (US); Hui Juan Chen, Shanghai (CN); You San Qian, Shanghai (CN)

(21) Appl. No.: 18/041,895

(22) PCT Filed: Aug. 16, 2021
(86) PCT No.: PCT/IB2021/057519

§ 371 Date: Feb. 16, 2023

(30) Foreign Application Priority Data
Aug. 17, 2020 (CN) 202010826107.7

(51) Int. Cl. A62B 18/08; B32B 27/06; B32B 27/20; B32B 27/08

(52) U.S. Cl. CPC A62B 18/08; B32B 27/065; B32B 27/205; B32B 27/08; B32B 2266/0214; B32B 2250/03; B32B 2305/022; B32B 2305/026; B32B 2307/7242; B32B 2571/00

(57) ABSTRACT

The present invention relates to a sealing foam, a respirator, and a method for manufacturing a sealing foam. The sealing foam includes: a main body part, the main body part being a porous foam; an air-proof film on a continuous surface; and an anchor layer, the anchor layer being continuously provided on the upper layer of the main body and provided between the air-proof film and the main body part, and the anchor layer being partially embedded in pores of the porous foam. The respirator includes a respirator main body and a sealing foam of the present invention. The method for manufacturing a sealing foam includes: providing a porous foam to prepare a main body part of a sealing foam, and providing an anchor layer and an air-proof film on the porous foam, so that the air-proof film is continuously provided on an upper surface of the main body part, wherein the anchor layer is provided between the air-proof film and the main body part, and is partially embedded in pores of the porous foam. The sealing foam, the respirator, and the method for manufacturing a sealing foam according to the present invention are convenient for subsequent cutting, can simplify the manufacturing process of the sealing foam, improve the sealing between the respirator and the face of a wearer, and improve the wearing comfort of the respirator.

### TECHNICAL FIELD

The present invention relates to the field of personal protection, and in particular, to a sealing foam, a respirator provided with the sealing foam, and a method for manufacturing a sealing foam.

### BACKGROUND

The content of this part provides only background information related to the present invention, and does not necessarily constitute the prior art.

As a commonly used protective article, a respirator is often used to protect against dust, mist, bacteria, etc., and is widely used in specific working environments and daily life. Ideally, when a respirator is worn, the respirator can fit the contour of the face of a wearer to form good sealing between the respirator and the face of the wearer. However, the contour of the face of the wearer is not a regular contour, and wearers have large individual differences. Especially, the contour of the nose is complex and fluctuates; it is often difficult to form good sealing with the respirator, and a gap is often present between the respirator and the nose area of the wearer, resulting in a poor sealing effect. As a result, in the one hand, dust, mist or bacteria in an environment where the wearer is located will be in contact with the wearer through the gap and is inhaled by the wearer, thus affecting the protective effect of the respirator. On the other hand, the exhaled breath of the wearer will also be discharged upwards through this gap. For the case where the wearer wears glasses, if the temperature in the respirator is higher than the ambient temperature, the exhaled breath will cause fogging on the glasses and affect the wearing experience of the wearer.

Therefore, in order to improve the protective effect of the respirator and improve the wearing experience, it is expected that the respirator can fit the contour of the face of the wearer and achieve good sealing between the respirator and the face of the wearer. In an existing respirator, a metal or plastic nasal foam with a memory effect is used. When this type of respirator is worn, by applying a pressure to this part of the respirator, the nasal foam of the respirator is deformed to fit the contour of the nose of the wearer, so that the sealing between the respirator and the nose of the wearer is improved, and the respirator is pressed against and fits the face of the wearer. However, the pressure applied to the nose of the wearer by the nasal foam part of such a respirator is prone to cause discomfort to the wearer, and it is easy to cause indentation and even cause trauma on the face of the wearer. The situation is particularly obvious when the respirator is worn for a long time.

### SUMMARY

An objective of the present invention is to provide an improved sealing foam and a respirator provided with the sealing foam, so as to improve the sealing performance of the sealing foam, improve the sealing between the respirator and the face of a wearer, and improve the wearing comfort of the respirator. Another objective of the present invention is to provide a method for manufacturing a sealing foam, as well as a sealing foam manufactured thereby and a respirator, so as to simplify the manufacturing process of the sealing foam, improve the sealing performance of the sealing foam, improve the sealing between the respirator and the face of the wearer, and improve the wearing comfort of the respirator.

One aspect of the present invention is to provide a sealing foam, comprising: a main body part, the main body part being a porous foam; an air-proof film, the air-proof film being continuously provided on an upper surface of the main body part; and an anchor layer, the anchor layer being provided between the air-proof film and the main body part, and the anchor layer being partially embedded in pores of the porous foam.

Another aspect of the present invention is to provide a respirator, the respirator comprises a respirator main body, and further comprises any sealing foam provided by the present invention. The sealing foam is attached to the respirator main body to cover at least a part of a peripheral edge of the respirator main body to be in contact with the face of a wearer.

Still another aspect of the present invention is to provide a method for manufacturing a sealing foam, comprising: providing a porous foam to prepare a main body part of a sealing foam, and providing an anchor layer and an air-proof film on the porous foam, so that the air-proof film is provided on an upper surface of the main body part, wherein the anchor layer is provided between the air-proof film and the main body part, and is partially embedded in pores of the porous foam.

Still another aspect of the present invention is to provide a sealing foam, and the sealing foam is manufactured by using the method for manufacturing the sealing foam according to the present invention.

Yet another aspect of the present invention is to provide a respirator, the respirator comprises a respirator main body, and the respirator further comprises a sealing foam manufactured by using the method for manufacturing the sealing foam according to the present invention.

Compared with the prior art in the art, the present invention has the advantages that: the sealing foam, the respirator, and the method for manufacturing the sealing foam according to the present invention can improve the sealing performance of the sealing foam, improve the sealing between the respirator and the face of a wearer, and improve the wearing comfort of the respirator. Moreover, it is easy to cut the foam, thus simplifying the manufacturing process of the foam.

### BRIEF DESCRIPTION OF THE DRAWINGS

The embodiments of the present invention are described below merely as examples with reference to the accompanying drawings. In the accompanying drawings, the same features or components are represented by the same reference numerals, and the accompanying drawings are not necessarily drawn to scale. Further, in the accompanying drawings:

FIG. 1 is a schematic view of a foam air permeability test apparatus used in the present invention.

FIG. 2 is a schematic cross-sectional structural view of a sealing foam according to a first embodiment of the present invention;

FIG. 3 is a perspective view of a sealing foam according to the first embodiment of the present invention;

FIG. 4 is a side view of a first respirator provided with the sealing foam according to the first embodiment of the present invention;

FIG. 5 is a perspective view of the first respirator in FIG. 4, in which the sealing foam of the first respirator is shown;

FIG. 6 is a front view of a second respirator provided with the sealing foam according to the first embodiment of the present invention; and

FIG. 7 is a perspective view of the second respirator in FIG. 6, in which the sealing foam of the second respirator is shown.

### DETAILED DESCRIPTION

The following descriptions are substantially merely exemplary, and are not intended to limit the present invention, the application, and the use. It should be understood that in all of the accompanying drawings, similar reference numerals represent the same or similar parts and features. The accompanying drawings illustratively show the idea and principles of the embodiments of the present invention, but do not necessarily show specific size of each embodiment of the present invention and the scale thereof. In some parts of specific accompanying drawings, related details or structures of the embodiments of the present invention may be illustrated in an exaggerated manner.

All figures for denoting characteristic dimensions, quantities and physicochemical properties used in this specification and claims are to be understood as modified by a term “about” in all situations, unless indicated otherwise. Therefore, unless stated conversely, parameters in numerical values listed in the above specification and the claims are all approximate values, and artisans in the art are capable of seeking to obtain desired properties by taking advantage of contents of the teachings disclosed herein, and changing these approximate values appropriately. The use of a numerical range represented by end points includes all figures within the range and any range within the range, for example, 1 to 5 includes 1, 1.1, 1.3, 1.5, 2, 2.75, 3, 3.80, 4, 5, and the like.

In the description of the embodiments of the present invention, related directional terms such as “upper,” “lower,” “left,” and “right” are used for description in upper, lower, left, and right positions in the views shown in the accompanying drawings. In practical applications, the positional relationships of “upper,” “lower,” “left,” and “right” used herein may be defined according to actual situations, and these relationships can be reversed.

According to the technical solution of the present invention, the term “porous” refers to a state in which a certain volume of solid material and a certain volume of pores are mixed.

According to the technical solution of the present invention, the term “porous foam” refers to a foam having a porous structure.

According to the technical solution of the present invention, the term “open pore” refers to a cavity and pore canal in the porous material that communicate with the external world. The foam with open pores can allow air to pass in one dimension and three dimensions because the pores are in communication with the surface of the porous material.

According to the technical solution of the present invention, the term “closed pore” refers to an independent pore structure in the porous material, and these pores are not in communication with the outer surface of the porous material. Generally, the material having the closed-pore structures has stronger rigidity and is not easily compressed.

According to the technical solution of the present invention, the term “respirator” refers to an apparatus worn by a person so as to filter the air before the air enters the respiratory system of the person.

According to the technical solution of the present invention, the term “respirator main body” refers to an air-permeable structure that can fit at least on the nose and mouth of a person and help define an internal air space that is separated from the external air space.

According to the technical solution of the present invention, the term “polymer” refers to a substance containing regularly or irregularly arranged repeating chemical units.

According to the technical solution of the present invention, the term “embedded” refers to that an uncured anchor layer material partially penetrates into open pores on the surface of the main body part, and a part of the anchor layer material remains in the pores after the anchor layer material is cured. The anchor layer connects the main body part and the air-proof film to form an integrated structure.

Various exemplary embodiments of the present invention are further described by a list of embodiments below, which should not be construed as unduly limiting the present invention:

Specific embodiment 1 is a sealing foam, including: a main body part, the main body part being a porous foam; an air-proof film, the air-proof film being continuously provided on an upper surface of the main body part; and an anchor layer, the anchor layer being provided between the air-proof film and the main body part, and the anchor layer being partially embedded in pores of the porous foam.

Specific embodiment 2 is the sealing foam according to the specific embodiment 1, wherein the air permeability of the sealing foam in a direction perpendicular to the upper surface of the main body part is not greater than 0.02 L/min.

Specific embodiment 3 is the sealing foam according to the specific embodiment 1, wherein the main body part of the sealing foam has a first side surface and a second side surface opposite to the first side surface, the second side surface is used for being attached to the respirator so that the sealing foam covers at least a part of a peripheral edge of the respirator main body of the respirator to be in contact with the face of a wearer, the first side surface faces the wearer, and the upper surface of the main body part faces the outside of the respirator.

Specific embodiment 4 is the sealing foam according to the specific embodiment 1, wherein the porous foam includes: polyurethane, polyvinyl chloride, polypropylene, polyethylene, polyethylene vinyl acetate, and rubber.

Specific embodiment 5 is the sealing foam according to the specific embodiment 1, wherein the porous foam includes an open-pore structure.

Specific embodiment 6 is the sealing foam according to the specific embodiment 1, wherein pores per linear inch of the porous foam is 40-85 PPI.

The specific embodiment 7 is the sealing foam according to the specific embodiment 1, wherein the air-proof film includes: a polyurethane film, a polyacrylate film, a neoprene film, a silicone rubber film, and a polyvinyl acetate film.

Specific embodiment 8 is the sealing foam according to the specific embodiment 1, wherein the air-proof film has a thickness of 5-20 microns.

Specific embodiment 9 is the sealing foam according to the specific embodiment 1, wherein the anchor layer has a thickness of 10-50 microns.

Specific embodiment 10 is the sealing foam according to the specific embodiment 1, wherein the anchor layer and the air-proof film are of the same material or different materials, including polyurethane, polyacrylate, neoprene, and polyvinyl acetate. If the anchor layer and the air-proof film are of the same material, no obvious boundary is observed between the anchor layer and the air-proof film, and the two layers form an integrated structure.

Specific embodiment 11 is the sealing foam according to the specific embodiment 1, wherein the anchor layer and the air-proof film are of the same material, and the air-proof film has a total thickness of 10-100 microns.

Specific embodiment 12 is a sealing foam, including: a main body part, the main body part being a porous foam, the porous foam including an open-pore structure having pores per linear inch of 40-85 PPI; an air-proof film, the air-proof film being continuously provided on an upper surface of the main body part; and an anchor layer, the anchor layer being provided between the air-proof film and the main body part, and the anchor layer being partially embedded in pores of the porous foam, wherein the air permeability of the sealing foam in a direction perpendicular to the upper surface of the main body part is not greater than 0.02 L/min.

Specific embodiment 13 is the sealing foam according to the specific embodiment 1, wherein the main body part includes a curved surface part, the curved surface part includes a first convex part, a concave part, and a second convex part that are sequentially provided in the lengthwise direction of the sealing foam, the concave part is configured to accommodate the nose of the wearer, and the first convex part and the second convex part are symmetrical about the concave part.

Specific embodiment 14 is a respirator, the respirator including a respirator main body, wherein the respirator further includes the sealing foam according to any one of the specific embodiments 1 to 13, and the sealing foam is attached to the respirator main body to cover at least a part of a peripheral edge of the respirator main body to be in contact with the face of a wearer.

Specific embodiment 15 is a method for manufacturing the sealing foam, including: providing a porous foam to prepare a main body part of a sealing foam, and providing an anchor layer and an air-proof film on the porous foam, so that the air-proof film is provided on an upper surface of the main body part, wherein the anchor layer is provided between the air-proof film and the main body part, and is partially embedded in pores of the porous foam.

Specific embodiment 16 is the method for manufacturing the sealing foam according to the specific embodiment 15, wherein the anchor layer and the air-proof film are of the same material, and the air-proof film and the anchor layer are formed on the porous foam in the following manner: preparing an air-proof film precursor, attaching it to one side surface of the porous foam when it is not completely cured, and curing it to form the air-proof film and the anchor layer.

Specific embodiment 17 is the method for manufacturing the sealing foam according to the specific embodiment 15, wherein the anchor layer and the air-proof film are of the same material or different materials, and the air-proof film and the anchor layer are formed on the porous foam in the following manner: preparing an air-proof film, coating an anchor layer material on one side surface thereof, attaching the side of the air-proof film sprayed with the anchor layer material on one side surface of the porous foam before the anchor layer material is completely cured, and curing the anchor layer material to form the anchor layer.

Specific embodiment 18 is the method for manufacturing the sealing foam according to the specific embodiment 16 or 17, further including cutting the sealing foam after the anchor layer is cured.

Specific embodiment 19 is a sealing foam, and the sealing foam is manufactured by using the method for manufacturing the sealing foam according to any one of the specific embodiments 15 to 18.

Specific embodiment 20 is a respirator, the respirator including a respirator main body, wherein the respirator further includes the sealing foam according to the specific embodiment 19.

The present invention will be described below in further detail in combination with embodiments. It needs to point out that, these descriptions and embodiments are all intended to make the invention easy to understand, rather than to limit the invention. The protection scope of the present invention is subject to the appended claims.

### EMBODIMENTS

In the present invention, unless otherwise pointed out, the reagents employed are all commercially available products, which are directly used without further purification.

TABLE 1
List of raw materials

| Chemical Name | Product Brand | Manufacturer |
|---|---|---|
| Polyester polyol | XCP1000 | Asahikawa Chemical Co., |
| | | Ltd. |
| Polyisocyanate | N3300 | Covestro Polymer China Co., |
| | | Ltd. |
| Cellulose acetate | CAB381 | Eastman Chemical China Co., |
| butyrate | | Ltd. |
| Dibutyltin dilaurate | — | Sinopharm Chemical Reagent |
| (DBTL) | | Company |
| Acetylacetone | — | Sinopharm Chemical Reagent |
| | | Company |
| Butanone | — | Sinopharm Chemical Reagent |
| | | Company |
| Polyacrylate | Neocryl A1092 | DSM Synthetic Resin Co., |
| emulsion | | Ltd. |
| Polyacrylate | 7015G | BASF China |
| emulsion | | |
| Polyurethane | UH2342 | Covestro Polymer China Co., |
| emulsion | | Ltd. |
| Neoprene emulsion | C84 | Covestro Polymer China Co. |
| | | Ltd. |
| PU foam | Polyester type | Shanghai Inoac Polymer |
| | | Products Co., Ltd. |
| BOPP film | With a thickness | Shanghai Lianshi International |
| | of 75 microns (the | Trade Co., Ltd. |
| | thickness data is | |
| | provided by clients) | |

### Testing Method

### Air Permeability

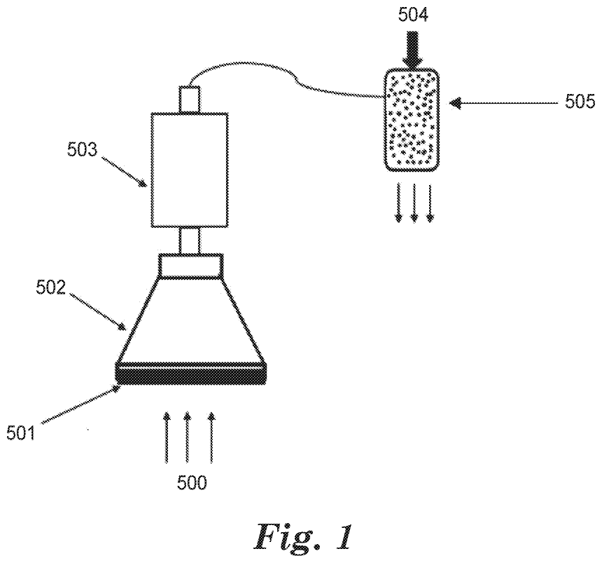

The air permeability of the foam is tested according to ASTM D3574 Test G. The sample area is 63.6 cm² (the effective diameter is 90 mm), the sample thickness is 10 mm, the test pressure is 250 Pa, the test range is 0-0.15 L/min, and the vacuum pump capacity (250 Pa) is 2.5 L/min. The air permeability of the sealing foam in the direction perpendicular to its upper surface is tested, with one side of the air-proof film facing an air intake direction, in liters per minute. The schematic view of a test apparatus is shown in FIG. 1, wherein 500 denotes the permeated air, 501 denotes a foam sample, 502 denotes a sample holder, 503 denotes a flowmeter (the accuracy of the flowmeter is 0.01 L/min), 504 denotes compressed air, and 505 denotes a vacuum generator.

TABLE 2
Foam samples and parameters thereof

| | Sample 1 | Sample 2 | Sample 3 | Sample 4 | Sample 5 |
|---|---|---|---|---|---|
| Gram weight | 30 | 30 | 26.5 | 30 | 32.5 |
| (kg/m³) | | | | | |
| Pores per | 60 | 75 | 50 | ≥45 | 60 |
| linear inch | | | | | |
| (PPI) | | | | | |

* The foam samples listed in Table 2 are only exemplary, and other types of foam other than the samples listed in Table 2 can also be used to prepare the sealing foam. The gram weight and pores per linear inch (PPI) data are from suppliers.

### Preparing Method

### Embodiment 1

Add 9.5 g XCP1000, 3.84 g N3300, 1.86 g CAB381 solution (35.7% by weight butanone solution), 0.19 g acetylacetone, 0.02 g DBTL (12% by weight butanone solution) into a 30 ml plastic bottle, mix them evenly, apply about 1 g of the above solution to the surface of an A4-sized BOPP film (having a thickness of 75 microns) using a wire rod, and cure at 100° C. for 10 minutes to obtain an air-proof polyurethane film (PU film) of about 10 microns on the BOPP film. Then apply a layer of 2-3 g of the above solution on the upper surface of the air-proof PU film using the same method, immediately attach the surface of the air-proof PU film coated with the above solution to one side surface of a PU foam (Sample 4), put it at the room temperature for 24 hours and cure to obtain a PU anchor layer having a thickness of 20-30 microns. After the BOPP film is removed, a sealing foam E1 including an air-proof PU skin layer and a PU anchor layer and having a high air-proof performance is obtained.

### Embodiments 2-4

For the preparation method of the sealing foam, reference can be manufactured to Embodiment 1, only the amount of the anchor layer material applied is different.

The air permeability of the sealing foam E1-E4 of which materials of the air-proof film and the anchor layer are polyurethane is measured. Details can be obtained with reference to Table 3. The air permeabilities of all sealing foam samples are not greater than 0.02 L/min.

TABLE 3
Structural parameters and air permeabilities of sealing foam E1-E4

| Sealing foam | E1 | E2 | E3 | E4 |
|---|---|---|---|---|
| Porous foam | Sample 4 | Sample 4 | Sample 4 | Sample 4 |
| Air-proof film thickness | 8 | 8 | 9 | 9 |
| (um) | | | | |
| Anchor layer thickness | 15 | 20 | 35 | 43 |
| (um) | | | | |
| Air permeability, L/min | 0.005 | 0.005 | 0.005 | 0.005 |

### Embodiment 5

Apply about 2 g of A1092 polyacrylate emulsion on an A4-sized BOPP film and cure at 100° C. for 5 minutes to obtain an air-proof film with a thickness of about 10 microns; then apply 2-3 g of polyurethane solution in Embodiment 1, immediately attach the surface of the air-proof PU film coated with the above solution to one side surface of a PU foam (Sample 4), and cure at the room temperature (25±2° C.) for 24 hours to obtain an anchor layer with a thickness of about 16 microns, thereby obtaining a sealing foam E5 with a polyacrylate air-proof film and a polyurethane anchor layer.

### Embodiment 6

Apply about 2 g of A1092 polyacrylate emulsion on an A4-sized BOPP film and cure at 100° C. for 5 minutes to obtain an air-proof film with a thickness of about 10 microns; then coat 2-3 g of C84 neoprene emulsion on the air-proof film, immediately attach the surface of the air-proof PU film coated with the above solution to one side surface of a PU foam (Sample 4), and cure at the room temperature (25±2° C.) for 24 hours to obtain an anchor layer with a thickness of about 11 microns, thereby obtaining a sealing foam E6 with a polyacrylate air-proof film and a neoprene anchor layer.

### Embodiment 7

Apply about 2 g of UH2342 polyurethane emulsion on an A4-sized BOPP film and cure at 100° C. for 5 minutes to obtain an air-proof film with a thickness of about 7 microns; then coat 2-3 g of 7015G polyacrylate emulsion on the air-proof film, immediately attach the surface of the air-proof PU film coated with the above solution to one side surface of a PU foam (Sample 4), and cure at the room temperature (25±2° C.) for 24 hours to obtain an anchor layer with a thickness of about 11 microns, thereby obtaining a sealing foam E7 with a polyurethane air-proof skin layer and a polyacrylate anchor layer.

TABLE 4
Structural parameters and air permeabilities of sealing foam E5-E7

| Embodiments | E5 | E6 | E7 |
|---|---|---|---|
| Porous foam | Sample 4 | Sample 4 | Sample 4 |
| Air-proof film material | Polyacrylate | Polyacrylate | Polyurethane |
| Air-proof film thickness | 10 | 10 | 7 |
| (um) | | | |
| Anchor layer material | Polyurethane | Neoprene | Polyacrylate |
| Anchor layer thickness | 16 | 11 | 11 |
| (um) | | | |
| Air permeability (L/min) | 0.005 | 0.005 | 0.005 |

The air permeabilities of the sealing foam E5-E7 are measured. Details can be obtained with reference to Table 4. The air permeabilities of all the sealing foam samples are not greater than 0.02 L/min.

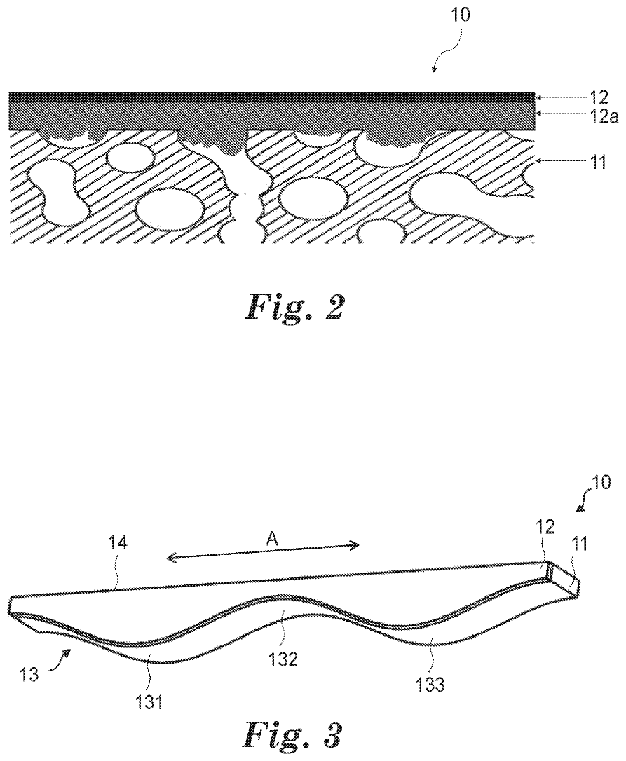

FIG. 2 is a schematic cross-sectional structural view of a sealing foam prepared according to Embodiment E1 of the present invention. As shown in FIG. 2, the porous foam serves as a main body part 11 of a sealing foam 10, and a polyurethane air-proof film 12a and a polyurethane anchor layer 12b are provided on the porous foam sequentially, wherein the anchor layer 12a is provided between the air-proof film 12 and the main body part 11, and the anchor layer 12a is partially embedded in pores of the porous foam serving as the main body part 11.

As shown in FIG. 3, the cut sealing foam 10 includes the flexible main body part 11 and the air-proof film 12. The main body part 11 is manufactured of flexible porous polyurethane foam. The air-proof film 12 is provided on an upper surface of the main body part 11. The thickness of the air-proof film formed on the foam can be set according to an application requirement of the sealing foam 10. In this embodiment, the anchor layer has a thickness of 15 microns, and the air-proof film has a thickness of 8 microns. The anchor layer (not shown in FIG. 3) and the air-proof film are both of polyurethane materials, and the air-proof film is anchored on the upper surface of the main body part 11 through the anchor layer. The sealing foam 10 has a first side surface 13 extending in the lengthwise direction of the sealing foam 10 (the direction indicated by a double-headed arrow A in FIG. 3) and a second side surface 14 opposite to the first side surface 13. The main body part 11 of the sealing foam 10 includes a first convex part 131, a concave part 132, and a second convex part 133 which are integrally formed with each other in the lengthwise direction of the sealing foam 10. The first convex part 131 and the second convex part 132 are symmetrical to each other about the concave part 132, and the smallest thickness of the concave part 132 is located at the longitudinal middle position of the main body part 11, so that the first side surface 13 of the sealing foam 10 is a curved surface having a sinusoidal contour with a constant amplitude in the lengthwise direction of the sealing foam 10. The second side surface 14 is a substantially flat surface to facilitate attachment of the sealing foam 10 to the target product. The target product may be, for example, a respirator. The sealing foam 10 can be used as a nasal foam for various respirators. When the sealing foam 10 is attached to the respirator, the second side surface 14 is attached to a respirator main body of the respirator, the first side surface 13 faces the wearer, and the air-proof film 12 faces the upper side. That is, the air-proof film 12 faces the outside the respirator, and the concave part 132 is configured to accommodate the nose of the wearer. For example, adhesive is sprayed on or applied to a position on the respirator main body where the sealing foam 10 is to be installed and/or the second side surface 14 of the sealing foam 10, so as to attach the second side surface 14 of the sealing foam 10 to the respirator main body.

Before the sealing foam 10 is cut, the air-proof film 12 of the sealing foam 10 has been anchored on one side surface of the porous foam through the anchor layer. Therefore, the air-proof film 12 does not need to be separately provided when each sealing foam 10 is prepared, which simplifies the manufacturing process of the sealing foam 10. Since the air-proof film is anchored on one surface of the main body part through the anchor layer, and the anchor layer has been partially embedded in the pores of the porous foam of the main body part, when the porous foam material is cut/sliced, the displacement of the air-proof film can be effectively reduced, thus optimizing the production process and improving the quality of the sealing foam. If an adhesive tape is used to fit the porous substrate to the air-proof film, it is not conducive to cutting/slicing, and a risk of air leakage is also present.

Secondly, by providing the above air-proof film 12, the material used for preparing the sealing foam 10 can be freely selected. For example, for 25% indentation generated, foam of which target pressure is in a range of 40 N to 500 N, preferably in a range of 60 N to 400 N, and more preferably in a range of 80 N to 350 N may be used to prepare the sealing foam of the present invention.

Thirdly, by providing the anchor layer, a porous foam substrate with high air permeability can be freely selected. Generally, the porous foam with open-pore structures and micro-pore structures has high permeability and good flexibility. The porous foam with closed-pore structures has high hardness, strong rigidity, and poor resilience. It is not easy to form a continuous air-proof film with a small thickness on the porous foam with large pores or a large porosity. By providing the anchor layer, an air-proof film having a small and controllable thickness can be formed on the porous foam. The air-proof film is anchored on the surface of the porous foam through the anchor layer, thus forming an integrated structure similar to an ultra-thin skin layer. The sealing foam can provide both adequate wearing comfort and sealing performance.

When the sealing foam provided by the present invention is used as a nasal foam of a respirator, the shape of the porous foam serving as the main body part may be a rectangular parallelepiped, a cylinder, or any other shape. The resilience performance of the foam itself and the sealing performance of the air-proof film can provide sufficient sealing performance and wearing comfort.

The sealing foam 10 according to the first embodiment of the present invention may be used as a nasal foam of a respirator, and may be applied to various respirators, for example, various earloop respirators, head-mounted respirators, etc.

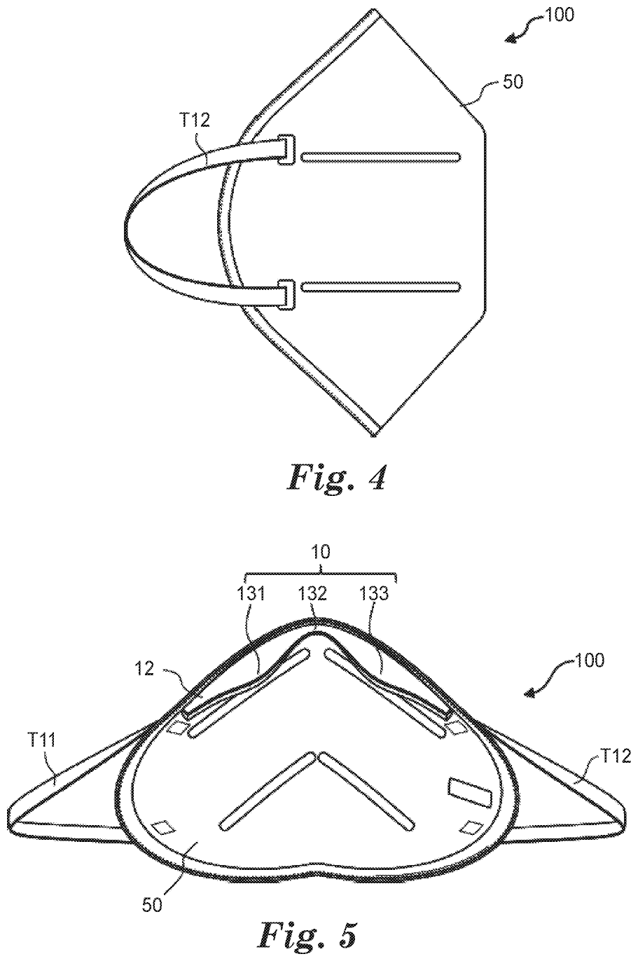

FIG. 4 is a side view of a first respirator 100 provided with the sealing foam 10, wherein an outer side of the first respirator 100 is shown. FIG. 5 is a perspective view of the first respirator 100, wherein a side (i.e., an inner side) of the first respirator 100 facing a wearer is shown. As shown in FIG. 4 and FIG. 5, the first respirator 100 is an earloop respirator. In the example shown in the drawing, the first respirator 100 is a foldable earloop respirator. However, the present invention is not limited thereto, and in other examples, the sealing foam 10 may also be applied to non-foldable earloop respirators. In the manufacturing process of the first respirator 100, the sealing foam 10 according to the first embodiment of the present invention is attached to an inner side of a respirator main body 50 of the first respirator 100, and the air-proof film 12 is located on an upper side. When the first respirator 100 is worn, a first lanyard T11 and a second lanyard T12 of the first respirator 100 are hung on the left and right ears of the wearer, respectively. The first respirator 100 is adjusted so that the nose of the wearer is accommodated in the concave part 132 of the sealing foam 10, and the first side surface 13 of the sealing foam 10 can conform to the contour of the face of the wearer to closely fit the periphery of the nose of the wearer, thus reducing or even eliminating the gap between the respirator and the nose of the wearer. By providing the above air-proof film 12, the sealing performance between the first respirator 100 and the periphery of the nose of the wearer can be significantly improved. Therefore, good sealing between the first respirator 100 and the face of the wearer can be achieved without the need of generating an excessively large pressure between the first respirator 100 and the face of the wearer. Moreover, the material of the sealing foam 10 is often softer than that of the respirator main body 50 of the first respirator 100. Therefore, during the process of adjusting the first respirator 100 to fit the contour of the face of the wearer, the sealing foam 10 may have a large deformation. On the one hand, the first respirator 100 can be adapted to wearers with different face contours. On the other hand, the deformation of the sealing foam 10 may cushion the force acting on the face of the wearer, thereby reducing the discomfort to the wearer. In addition, the sealing foam 10 with the air-proof film 12 is provided on the inner side of the first respirator 100, and therefore the exhaled breath of the wearer will not be discharged upwards from between the first respirator 100 and the nose of the wearer, so that the situation of steaming up the glasses of the wearer can be completely alleviated or even avoided.

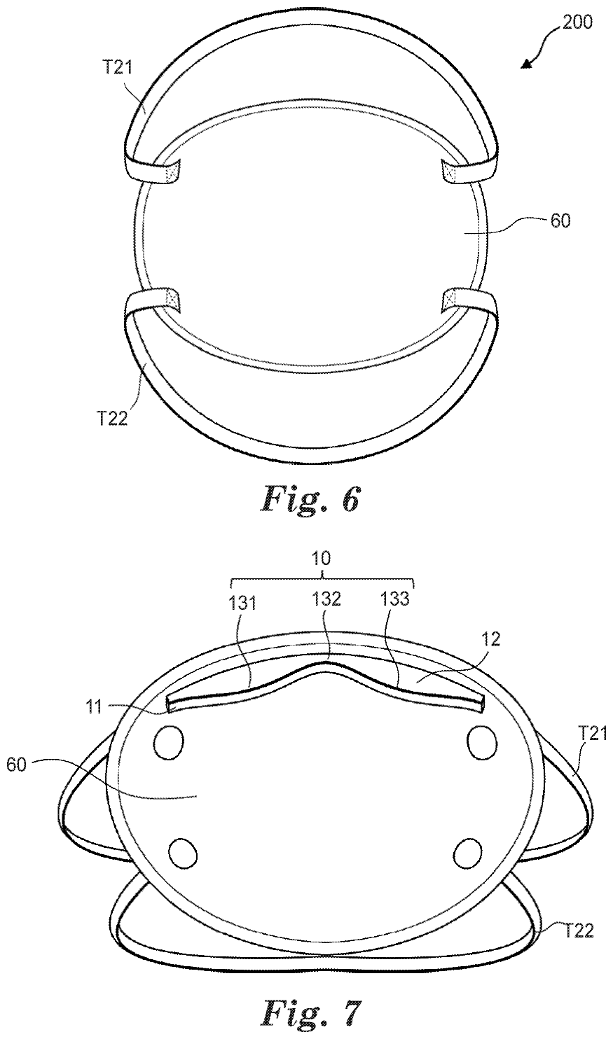

FIG. 6 is a front view of a second respirator 200 provided with the sealing foam 10, wherein an outer side of the second respirator 200 is shown. FIG. 7 is a perspective view of the second respirator 200, wherein a side (i.e., an inner side) of the second respirator 200 facing the wearer is shown. As shown in FIG. 6 and FIG. 7, the second respirator 200 is a head-mounted respirator. In the example in the drawing, the second respirator 200 is a non-foldable bowl-shaped head-mounted respirator. However, the present invention is not limited thereto, and the sealing foam 10 may also be applied to foldable head-mounted respirators. In the process of manufacturing the second respirator 200, the sealing foam 10 according to the first embodiment of the present invention is attached to an inner side of a respirator main body 60 of the second respirator 200, and the air-proof film 12 is located on an upper side. When the second respirator 200 is worn, the head of the wearer passes through a first lanyard T21 and a second lanyard T22 of the second respirator 200 respectively, so as to hang the first lanyard T21 and the second lanyard T22 on the head or neck of the wearer. The second respirator 200 is adjusted so that the nose of the wearer is accommodated in the concave part 132 of the sealing foam 10, and the first side surface 13 of the sealing foam 10 can conform to the contour around the nose of the wearer to closely fit the periphery of the nose of the wearer, thus achieving good sealing between the second respirator 200 and the nose of the wearer. The second respirator 200 provided with the sealing foam 10 can achieve similar beneficial effects as the first respirator 100 described above.

The sealing foam 10 according to the first embodiment of the present invention and the method for manufacturing the same, as well as various respirators provided with the sealing foam 10 are described above.

The sealing foam according to the preferred embodiment of the present invention, various respirators provided with the sealing foam according to the present invention, and the method for manufacturing the sealing foam have been described above with reference to the accompanying drawings. The sealing foam, the respirator provided with the sealing foam, and the method for manufacturing the sealing foam according to the present invention can simplify the manufacturing process of the sealing foam, increase the selection range of the porous foam substrate, improve the sealing performance between the respirator and the face of the wearer, and at the same time alleviate or avoid indentation or trauma on the face of the wearer, thus improving the wearing comfort of the respirator.

In the above embodiment, the application of the sealing foam according to the present invention in a respirator is shown with the respirator as the target product.

However, it should be understood that the sealing foam according to the present invention may also be applied to target products other than respirators.

Here, the exemplary embodiments of the present invention have been described in detail. However, it should be understood that the present invention is not limited to the detailed description above and the illustrated specific embodiments. Persons skilled in the art can make various variants of the present invention without departing from the subject and scope of the present invention. All these variants fall within the scope of the present invention. In addition, all members described herein can be replaced with other technically equivalent members.

1. A sealing foam, comprising:
a main body part, the main body part being a porous foam;
an air-proof film, the air-proof film being continuously provided on an upper surface of the main body part; and
an anchor layer, the anchor layer being provided between the air-proof film and the main body part, and the anchor layer being partially embedded in pores of the porous foam.

2. The sealing foam according to claim 1, wherein the air permeability of the sealing foam in a direction perpendicular to the upper surface of the main body part is not greater than 0.02 L/min.

3. The sealing foam according to claim 1, wherein the main body part of the sealing foam has a first side surface and a second side surface opposite to the first side surface, the second side surface is used for being attached to the respirator so that the sealing foam covers at least a part of a peripheral edge of the respirator main body of the respirator to be in contact with the face of a wearer, the first side surface faces the wearer, and the upper surface of the main body part faces the outside of the respirator.

4. The sealing foam according to claim 1, wherein the porous foam comprises: polyurethane, polyvinyl chloride, polypropylene, polyethylene, polyethylene vinyl acetate, and rubber.

5. The sealing foam according to claim 1, wherein the porous foam comprises an open pore structure.

6. The sealing foam according to claim 5, wherein pores per linear inch of the porous foam is 40-85 PPI.

7. The sealing foam according to claim 1, wherein the air-proof film comprises: a polyurethane film, a polyacrylate film, a neoprene film, a silicone rubber film, and a polyvinyl acetate film.

8. The sealing foam according to claim 1, wherein the air-proof film has a thickness of 5-20 microns.

9. The sealing foam according to claim 1, wherein the anchor layer has a thickness of 10-50 microns.

10. The sealing foam according to claim 1, wherein the anchor layer and the air-proof film are of the same material or different materials, comprising polyurethane, polyacrylate, neoprene, and polyvinyl acetate.

11. The sealing foam according to claim 10, wherein the anchor layer and the air-proof film are of the same material, and the air-proof film has a total thickness of 10-100 microns.

12. The sealing foam according to claim 1, wherein the main body part comprises a curved surface part, the curved surface part comprises a first convex part, a concave part, and a second convex part that are sequentially provided in the lengthwise direction of the sealing foam, the concave part is configured to accommodate the nose of the wearer, and the first convex part and the second convex part are symmetrical about the concave part.

13. A respirator, the respirator comprising a respirator main body, wherein the respirator further comprises the sealing foam according to claim 1, and the sealing foam is attached to the respirator main body to cover at least a part of a peripheral edge of the respirator main body to be in contact with the face of a wearer.

14. A method for manufacturing a sealing foam, comprising: providing a porous foam to prepare a main body part of a sealing foam, and providing an anchor layer and an air-proof film on the porous foam, so that the air-proof film is provided on an upper surface of the main body part, wherein the anchor layer is provided between the air-proof film and the main body part, and is partially embedded in pores of the porous foam.

15. The method for manufacturing the sealing foam according to claim 14, wherein the anchor layer and the air-proof film are of the same material, and the air-proof film and the anchor layer are formed on the porous foam in the following manner: preparing an air-proof film precursor, attaching the same to one side surface of the porous foam when not completely cured, and curing the same to form the air-proof film and the anchor layer.

16. The method for manufacturing the sealing foam according to claim 14, wherein the anchor layer and the air-proof film are of the same material or different materials, and the air-proof film and the anchor layer are formed on the porous foam in the following manner: preparing an air-proof film, coating an anchor layer material on one side surface thereof, attaching the side of the air-proof film coated with the anchor layer material on one side surface of the porous foam before the anchor layer material is completely cured, and curing the anchor layer material to form the anchor layer.

17. The method for manufacturing the sealing foam according claim 15, further comprising cutting the foam after the anchor layer is cured.

18. A sealing foam, wherein the sealing foam is manufactured by using the method for manufacturing the sealing foam according to claim 14.

19. A respirator, the respirator comprising a respirator main body, wherein the respirator further comprises the sealing foam according to claim 18.
